(19) United States
(12) Patent Application Publication
(10) Pub. No.: US 2005/0042013 A1
(43) Pub. Date: Feb. 24, 2005

(54) Key cap and manufacturing method thereof

(75) Inventor: Ton Lee, Taipei (TW)

Correspondence Address: BIRCH STEWART KOLASCH & BIRCH, PO BOX 747, FALLS CHURCH, VA, 22040-0747, US

(73) Assignee: Lite-on Technology Corporation, Taipei (TW)

(21) Appl. No.: 10/898,171

(22) Filed: Jul. 26, 2004

(30) Foreign Application Priority Data
Aug. 22, 2003 (TW) 92123185

(51) Int. Cl. B41J 5/08

(52) U.S. Cl. 400/490

(57) ABSTRACT

An improved key cap for a keyboard and a manufacturing method for the same are used to manufacture an improved key cap. The key cap has a key and a protective layer. The key is printed with a predetermined symbol or figure, or the protective layer is printed with a predetermined symbol or figure onone side thereof. The protective layer is then attached on the key.

### BACKGROUND OF THE INVENTION

1. Field of the Invention

The present invention relates to an improved key cap for a keyboard and a manufacturing method thereof, and especially to an improved structure of the contact portion on the key cap and a manufacturing method for providing a key cap with variety and protection against erosion.

2. Description of Prior Art

Keyboards are increasingly important due to the popularity of wire/wireless transmission device like remote controller, phone or data processing devices likes computer, PDA, . . . and so on. In particular, various symbols are written on a key cap, indicating various inputs and functions, such as, for example, letters, numbers and figures.

However, the key cap of prior art has disadvantages as follows:
1. The symbols, like letters, numbers, and figures, are usually directly printed on the key cap, and they are easily worn from the key cap after a period of time, especially when the key caps are used frequently, are continuously touched, and are corroded by sweat.
2. The surface of the key cap is not flat but rather slightly concave with protrusions or ribs thereon for the comfort and convenience of the user. This shape makes printed symbols on the key cap very difficult because the printed position is easily shifted. The defects of products thus are higher.
3. The symbols on the key cap are usually printed in different colors for easy differentiation by the user, and thus need to be printed with different colors, batch by batch. The colors are frequently shifted and are difficult to print.
4. It is very difficult to clean the surface of the key cap; moreover, cleaning agents or cleaning waxes may also erase the symbols which are printed on the surface thereof.

To resolve the problem of symbol erosion, some conventional key cap symbols are printed in a shallow recess in the key cap to prevent the direct contact between the symbols anduser's fingers. This method requires an additional process. It is difficult when figures or complicated characters need to be printed.

Another conventional solution has been disclosed in R.O.C. Patent No. 162874, in which the key cap has a pressing portion on a lower layer, and an enchasing cover enchased with a predetermined hollow character and disposed on the pressing portion. Each pressing portion protrudes with the same predetermined character and fills the hollow character. A light is disposed under the pressing portion. However, the related manufacturing processes are very complex, and are limited to apply to the filed. Therefore, preventing key cap symbol from erosion is extremely desirable from the user's viewpoint, while a fast and convenient method of key cap symbol printing would have great industrial utility. The inventor, after investigation and research, thus provides an improved key cap for a keyboard and a manufacturing method thereof.

### SUMMARY OF THE INVENTION

An object of the present invention is to provide an improved key cap for a keyboard, which key cap is formed with many types of symbols and protects the symbols thereon from erosion, and a manufacturing method thereof.

In order to achieve the above objects, the present invention provides a key pad for a keyboard. The key pad comprises a key and a protective layer. One side of the protective layer is printed with a character/symbol/figure or an inverse character/symbol/figure. The side is adhered to the key.

In order to achieve the above objects, the present invention provides a manufacturing method of the key pad for a keyboard, comprising steps described in the following. A protective layer is provided. A character/symbol/figure or an inverse character/symbol/figure is printed on one side of the protective layer. A key lower die formed with at least one mold cavity therein is provided. The protective layer for the printed character/symbol/figure is moved to mate with the corresponding mold cavity of the key lower die. A key upper die formed with an injecting mouth therein for injecting plastic material is provided. Plastic material is injected into the injecting mouth. Finally, the key is removed.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 is an exploded view of the present invention of a key cap of keyboard;

FIG. 2 is a process flow chart for manufacturing the present invention;

FIG. 3 is an exploded view of another embodiment of the present invention;

FIG. 4 is a process flow chart for manufacturing the present invention of the other embodiment; and

FIG. 5 is an exploded view according to the other embodiment of the present invention.

### DESCRIPTION OF THE PREFERRED EMBODIMENT

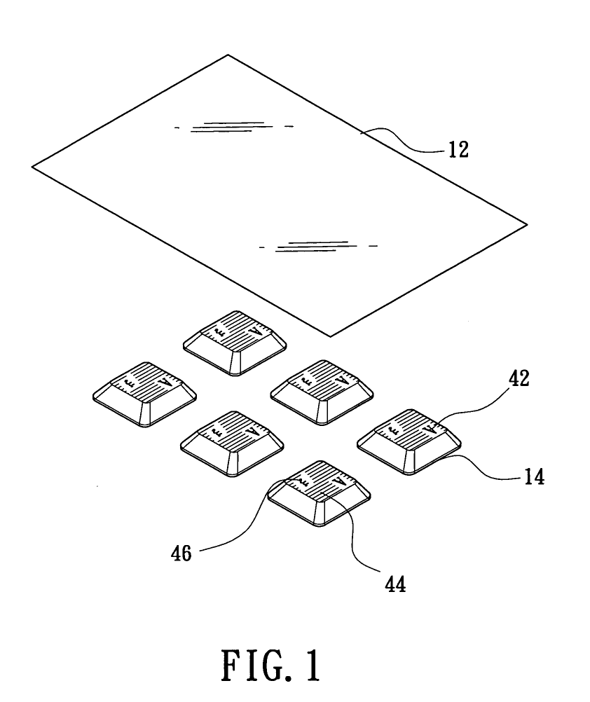

Referring to FIG. 1, an exploded view of the present invention of a key cap of keyboard is presented. The key caps comprise keys 14 that are respectively printed with a character/symbol 42, and a bottom color 44 or a figure 46 thereon. A protective layer 12 is transparent and is disposed on the keys 14. The protective layer 12 is melted on one side and adhered to the keys 14 by heating and pressing, and then trimming the protective layer 12 along the edges of the keys 14. Therefore, the key caps are protected, and the character/symbol 42, the bottom color 44 and the figure 46 thereon are also prevented from corrosion by sweat.

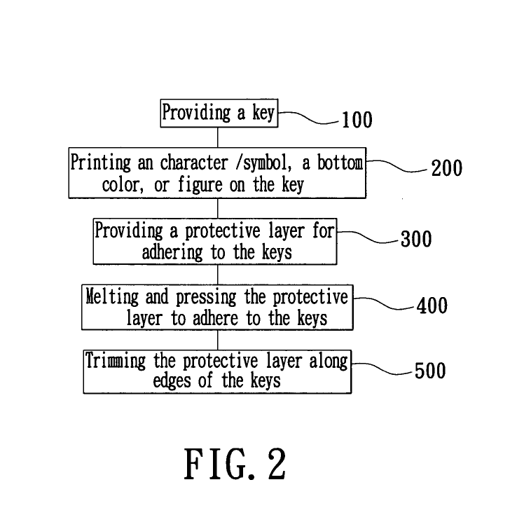

Referring to FIG. 2, the manufacturing steps of the key caps are described in the following. First, as shown by the step 100, a key 14 is provided. In step 200, a pattern, such as acharacter/symbol 42, a bottom color 44, or afigure 46, is printed on the key 14. In step 300, a protective layer 12 is provided for adhering to the keys 14, wherein the keys 14 can be disposed in a fixing tool (not shown). In step 400, the protective layer 12 is melted and pressed to adhere to the keys 14. In step 500, the protective layer 12 is trimmed along edges of the keys 14, so that the above steps accomplish the finished product.

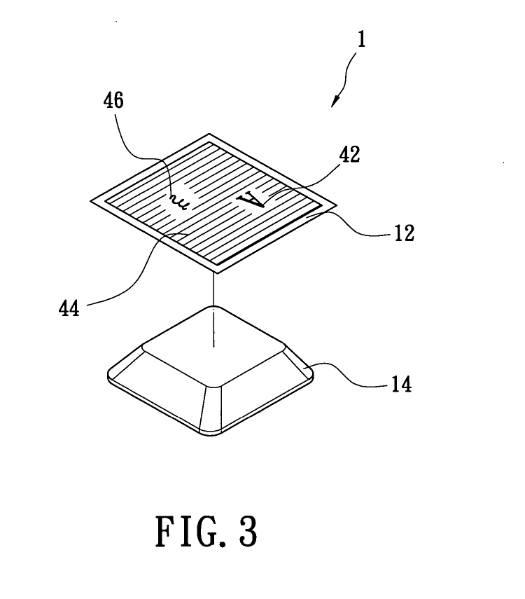

Reference is made to FIG. 3, which is a perspective view of another embodiment of the present invention. First, the transparent protective layer 12 is printed with an obverse/or inverse character/symbol 42 or afigure 46 onone side thereof. If necessary, a bottom color 44 is printed firstly by halftone printing, and then the obverse/or inverse character/symbol 42 or an obverse/or inversefigure 46 is printed. The protective layer 12 is adhered to the keys 14 by the side which is printed, by heating or adding a binder.

Because the character/symbol 42 or the figure 46 is printed ahead on the flat protective layer 12, the printing does not shift. The colors and forms are printed conveniently, so that the keyboard is visually stimulating and aesthetically pleasing.

The material of the protective layer 12 is, for example, polyester film or heat malleable plastic, such as polyvinyl chloride and polypropylene.

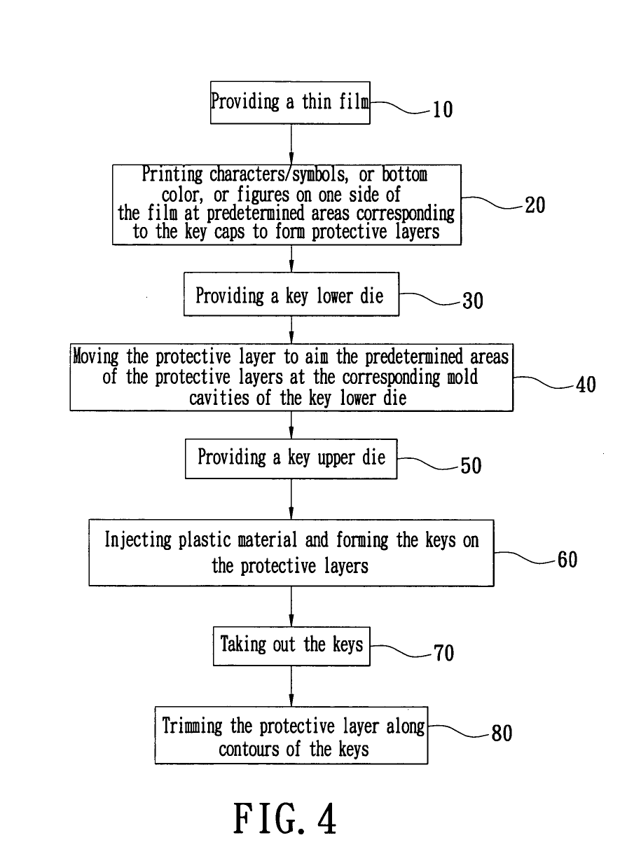

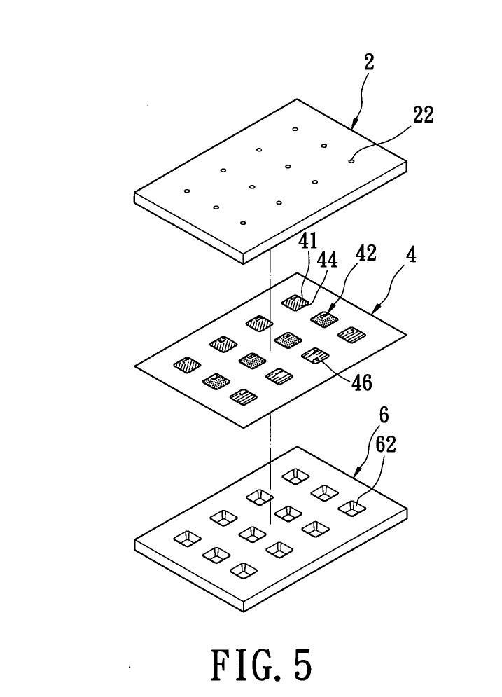

Reference is made to FIGS. 4 and 5, which are a perspective view and a flow chart of the manufacturing processes, respectively, of the above-described second embodiment.

First, as shown in step 10, a thin film 4 is provided, and film 4 is large enough to cover a plurality of key caps, so that plural predetermined figures can be printed thereon in one printing episode.

In step 20, the characters/symbols 42, the bottom color 44, orthe figures 46 are printed in predetermined areas 41 onone side of the film 4. The predetermined areas 41 mate with the key caps to cover surfaces of the key caps as protective layers 12.

In step 30, a key lower die 6, which is formed with at least one mold cavity 62 therein, is provided, and the mold cavity 62 is mated with a front portion of the key cap 1.

In step 40, the film 4 is affixed to the key lower die 6, and the predetermined areas 41 are aligned with the corresponding mold cavities 62 of the key lower die 6.

In step 50, a key upper die 2 formed with mold cavities (not shown) in one side is provided, and the other side thereof is formed with plural injecting mouths 22 therein for injecting plastic material into the mold cavities.

In step 60, plastic material is injected from the injecting mouth 22 of the key upper die 2, and the keys 14 are formed directly on the protective layers 12.

And the step 70, after the plastic material is cooled, the key upper die 2 is separated from the key lower die 6 and the keys 14 are removed.

The manufacturing method of the key caps of keyboard further comprises a step of trimming the protective layer 12 along edges of the keys 14. Therefore, the keys 14 are quickly formed and adhered to the protective layers 12, not only omitting the adhesive process but also quickening the manufacturing speed.

The present invention can further provide a carrying layer, which is separably attached with the protective layer and trimming ahead according to the contours of the key caps. The key is thereby easily separated from the carrying layer after shaping and need not be trimmed.

In conclusion, the present invention has the following advantages and characteristics:
1. The symbols on the key cap can be separately printed so that they are full of variety and convenient.
2. The protective layer protects the symbol on the key cap from erosion, thus eliminating the disadvantage of traditional keyboard.
3. When cleaning the key cap, the symbol thereon will not be removed. The key cap is thus easily kept clean.
4. The manufacturing method is quick and convenient, and has the great industrial utility.

Although illustrated and described herein with reference to certain specific embodiments, the present invention is nevertheless not intended to be limited to the details shown. Rather, various modifications may be made in the details within the scope and range of equivalents of the claims and without departing from the invention.

1. A key pad for a keyboard, comprising:
a key; and
a protective layer printed with a character/symbol or a figure on one side thereof, wherein the side of the protective layer is adhered to the key.

2. The key pad for a keyboard as in claim 1, wherein the protective layer has a color tint.

3. The key pad for a keyboard as in claim 1, wherein the protective layer is meltedto adhere to the key.

4. The key pad for a keyboard as in claim 1, wherein the protective layer is adhered to the key with adhesive.

5. The key pad for a keyboard as in claim 1, wherein the protective layer further has a transferring film thereon for adhering to the key.

6. The key pad for a keyboard as in claim 1, wherein the character/symbol is printed inversely on the protective layer.

7. The key pad for a keyboard as in claim 1, wherein the figure is printed inversely on the protective layer.

8. A key pad for a keyboard, comprising:
a key with a character/symbol or a figure printed thereon; and
a protective layer adhered to the key.

9. The key pad for a keyboard as in claim 8, wherein the protective layer has a color tint.

10. The key pad for a keyboard as in claim 8, wherein the protective layer is melted and pressed for adhering to the key.

11. A method for manufacturing a key cap of keyboard, comprising the steps of:
providing a protective layer;
printing a character/symbol or a figure on one side of the protective layer;
providing a key lower die formed with at least one mold cavity therein;
moving the protective layer for the printed character/symbol or inverse figure mating with the corresponding mold cavity of the key lower die;
providing a key upper die formed with an injecting mouth therein for injecting plastic material;
injecting plastic material into the injecting mouth; and
taking out the key.

12. The method for manufacturing a key cap of keyboard as in claim 11, further comprising a step of trimming the protective layer along a contour of the key.

13. The method for manufacturing a key cap of keyboard as in claim 11, wherein the protective layer is formed corresponding to a size of the key, and separably attached with a carrying layer, whereby the key is easily separated from the carrying layer after shaping and need not be trimmed.

14. The method for manufacturing a key cap of keyboard as in claim 11, wherein the character/symbol is printed inversely on the protective layer.

15. The method for manufacturing a key cap of keyboard as in claim 11, wherein the figure is printed inversely on the protective layer.
